(19) United States
(12) Patent Application Publication
(10) Pub. No.: US 2023/0311238 A1
(43) Pub. Date: Oct. 5, 2023

(54) INSULATED ELECTRODE FIXTURE FOR RESISTANCE WELDING AND METHOD OF WELDING USING SAME

(71) Applicant: BWXT Advanced Technologies LLC, Lynchburg, VA (US)

(72) Inventors: Earl B. BARGER, Goode, VA (US); Scott L. FITZNER, Appomattox, VA (US); Jeffrey T. LEE, Forest, VA (US)

(73) Assignee: BWXT Advanced Technologies LLC, Lynchburg, VA (US)

(21) Appl. No.: 18/127,019

(22) Filed: Mar. 28, 2023

Related U.S. Application Data
(60) Provisional application No. 63/324,691, filed on Mar. 29, 2022.

(51) Int. Cl. B23K 11/31

(52) U.S. Cl. CPC B23K 11/31

(57) ABSTRACT

Insulated electrode fixture has an electrically conductive body with a receiving channel configured to receive a workpiece and an insert that is electrically isolated from the electrically conductive body is located on the first side and circumferential to the receiving channel. During welding processes, portions of the surface of the electrode fixture are electrically insulated from contact by a weld upset by the electrically isolated insert. Variations include an electrically isolated insert located on or inset into the surface of the electrode fixture, an insert of a non-conductive material located on or inset into the surface of the electrode fixture, an insert with a coating of a non-conductive material located on or inset into the surface of the electrode fixture, a non-conductive coating on the electrode fixture (except for in areas designated for conducting the weld current during resistance welding), or combinations thereof.

### RELATED APPLICATION DATA

The application is based on and claims priority under 35 U.S.C. § 119 to U.S. Provisional Application No. 63/324,691, filed Mar. 29, 2022, the entire contents of which are incorporated herein by reference.

### TECHNICAL FIELD AND INDUSTRIAL APPLICABILITY

The present disclosure relates generally to fixtures for welding and methods of welding. In particular, an insulated electrode fixture for resistance welding, such as upset welding, and method of resistance welding utilizing the insulated electrode fixture are disclosed. Resistance welding utilizing the insulated electrode fixture can be utilized in various welding applications, particularly for welding of nuclear components.

### BACKGROUND

In the discussion that follows, reference is made to certain structures and/or methods. However, the following references should not be construed as an admission that these structures and/or methods constitute prior art. Applicant expressly reserves the right to demonstrate that such structures and/or methods do not qualify as prior art against the present invention.

Resistance welding is the joining of metal workpieces by applying pressure and passing current for a length of time through the area which is to be joined. In general, resistance welding creates welds using heat generated by resistance to the flow of welding current between the faying surfaces of workpieces to be joined and force pushing the workpieces together, applied over a defined period of time. There are several different forms of resistance welding, including spot and seam, projection, flash, and upset welding.

Resistance spot welding uses the face geometries of the welding electrodes themselves to focus the welding current at the desired weld location, as well as to apply force to the workpieces. Once sufficient resistance is generated, the materials set down and combine, and a weld is formed. Resistance seam welding uses wheel-shaped electrodes to deliver force and welding current to the parts. Resistance seam welding differs from resistance spot welding in that, in resistance seam welding, the workpiece rolls between the wheel-shaped electrodes while weld current is applied. Depending on the particular weld current and weld time settings, the welds created may be overlapping, forming a complete welded seam, or may simply be individual spot welds at defined intervals.

Projection welding localizes the welds at predetermined points by using projections, embossments or intersections, all of which focus heat generation at the point of contact. Once the weld current generates sufficient resistance at the point of contact, the projections collapse, forming the weld.

Flash welding generates resistance using flashing action that is created using very high current density at very small contact points between the workpieces. At a predetermined point after the flashing process has begun, force is applied to the workpiece, and they are moved together at a controlled rate. Rapid upset created by this force expels oxides and impurities from the weld.

Upset welding produces coalescence simultaneously over the entire area of abutting surfaces or progressively along a joint, by the heat obtained from resistance to electric current through the area where those surfaces are in contact. In upset welding, the force pushing the workpieces together is applied before the current is started, and the force is maintained until the process is complete. Because the workpieces are already in firm contact with one another, no flashing occurs. While the force is being applied, high-amperage current is passed through the joint, which heats the abutting surfaces. When they have been heated to a suitable forging temperature, an upsetting force is applied and the current is stopped. The high temperature of the work at the abutting surfaces plus the high pressure causes coalescence to take place. Also, the rapid upset created by the force expels oxides and impurities from the weld. After cooling, the force is released and the weld is completed.

However, in resistance welding, as the weld upset grows and contacts the weld electrodes, the weld current begins to bypass the weld joint by flowing through the weld upset into the electrodes. When this occurs, additional current primarily contributes to heating the components instead of heating the joint between the components being welded. Hence, the weld can no longer be improved once the upset contacts the electrode. This effect is exaggerated with high temperature and super alloy materials. Also, once the weld upset begins diverting weld current away from the joint interface, the weld current no longer applies heat directly to the joint, and sometimes results in liquifying the weld upset resulting in a weld blowout. Additionally, the hot material of the weld upset can adhere to the electrode composed of a material (copper alloy) with a lower melting point.

### SUMMARY

Thus, there is a need for improved resistance welding equipment, such as insulated electrodes, and for improved resistance welding methods that address the bypassing of current from weld upsets during resistance welding.

The present disclosure provides structures and methodologies to electrically insulate portions of the surface of the electrode fixture from contact by a weld upset. Embodiments of an insulated electrode fixture for resistance welding comprise a feature that electrically insulates the surface of the electrode fixture capable of contacting the weld upset from the weld upset.

For example, an embodiment of an insulated electrode fixture comprises an electrically conductive body including a first side, a second side, and a receiving channel extending through the electrically conductive body from the first side to a second side, an insert located on the first side and circumferential to the receiving channel. The receiving channel is configured to receive a workpiece with surfaces of the receiving channel in electrical conductive contact with the electrically conductive body, and the insert is electrically isolated from the electrically conductive body.

Electrically insulating the surface of the electrode fixture capable of contacting the weld upset can take various forms, including an electrically isolated insert that is located on or inset into the surface of the electrode fixture, an insert of a non-conductive material that is located on or inset into the surface of the electrode fixture, an insert with a coating of a non-conductive material that is located on or inset into the surface of the electrode fixture, a non-conductive coating on the electrode fixture (except for in areas designated for conducting the weld current during resistance welding), or combinations thereof.

Embodiments of the disclosed insulated electrode fixtures can be utilized in resistance welding systems and resistance welding methods and electrical insulate the surface of the electrode fixture from contact by a weld upset.

In additional aspects, electrically insulating the surface of the electrode fixture capable of contacting the weld upset allows many weld process parameters to be employed, such as forging and more weld force, which contribute to improved weld quality.

In further aspects, electrically insulating the surface of the electrode fixture capable of contacting the weld upset provides an electrically insulated surface that constrains the weld upset, which can virtually eliminate the outer weld upset (in other words, the weld upset only occurs on the inside of the tubing being resistance welded) and/or which allows for forming, forging and/or shaping of the weld upset. Also, eliminating the outer weld upset, removes the need for a post-weld machining operation.

Embodiments of an insulated electrode fixture have application in various welding process, such as resistance welding, and application in a wide range of fields, including automotive, aerospace, and industrial applications.

### BRIEF DESCRIPTION OF THE DRAWINGS

The foregoing summary, as well as the following detailed description of the embodiments, can be better understood when read in conjunction with the appended drawings. It should be understood that the embodiments depicted are not limited to the precise arrangements and instrumentalities shown.

FIG. 1 is a schematic representation illustrating the joining of two workpieces by upset welding.

FIGS. 2A and 2B are schematic, perspective views of an embodiment of an insulated electrode fixture for resistance welding, with FIG. 2A showing an assembled view and FIG. 2B showing a disassembled, partial view with a workpiece.

FIGS. 3A and 3B are schematic, perspective views of another embodiment of an insulated electrode fixture for resistance welding, with FIG. 3A showing an assembled view and FIG. 3B showing a disassembled, partial view with a workpiece.

FIGS. 4A and 4B are images of another example insulated electrode fixture for resistance welding, with FIG. 4A showing an assembled view and FIG. 4B showing a disassembled, partial view.

FIG. 5 is a schematic, perspective view of an additional embodiment of an insulated electrode fixture for resistance welding.

FIG. 6 is a schematic, perspective view of a further embodiment of an insulated electrode fixture for resistance welding.

FIG. 7 is an image of an example insulated electrode fixture for resistance welding.

FIG. 8 is a prior art image 800 of resistance welding of an end cap to a tube and showing the weld upset and a non-insulated electrode fixture for resistance welding.

In some instances, dimensions of respective constituent elements are appropriately adjusted for clarity. For ease of viewing, in some instances only some of the named features in the figures are labeled with reference numerals.

### DETAILED DESCRIPTION

Embodiments of the insulated electrode fixture for resistance welding and embodiments of the resistance welding method comprising electrically insulating the surface of one or both electrode fixtures will be described herein with reference to upset welding. However, it should be understood that the disclosed fixtures, structures, methods, solutions, and concepts can be applied to various resistance welding techniques where surfaces that are electrically insulating are desired.

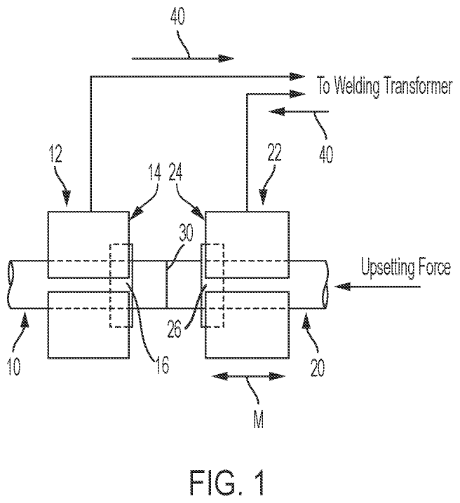

FIG. 1 is a schematic representation illustrating the joining of two workpieces by upset welding. As shown in FIG. 1, a first workpiece 10 is positioned in a first electrode fixture 12 and a second workpiece 20 is positioned in a second electrode fixture 22. To move the faying surfaces of the workpieces 10, 20 into contact with each other (at the weld joint 30) and to continue to apply a force urging the workpieces 10, 20 toward each other during the upset welding process, such as an upsetting force, either (a) one of the first electrode fixture 12 and the second electrode fixture 22 is stationary and the other is moveable or (b) both the first electrode fixture 12 and the second electrode fixture 22 are moveable. In the example shown in FIG. 1, first electrode fixture 12 is stationary and second electrode fixture 22 is moveable (as indicated by arrow M).

The electrode fixtures 12, 22 are connected to a welding transformer and provide electrical connection to the respective workpiece 10, 20 so as to function as electrodes in the upset welding process. In example embodiments, each of the electrode fixtures positioned about the respective workpieces can be a clamshell-type electrode that includes a clamping function, e.g., can engage with the workpiece with a clamping force, such as a circumferential clamping force. The workpiece is positioned in a receiving channel that is sized to engage the workpiece with an interference fit between the electrode fixture and the workpiece sufficient for electricity to flow from the electrode fixture to the workpiece during the welding process. The weld joint 30 is typically of highest resistivity along the electrical current path such that, when weld current (indicated by arrow 40) is applied to the system, the weld energy is focused at the weld joint 30 versus the weld current being distributed throughout the components being welded.

As the components are welded together, a weld upset can form in the region of the weld joint 30. A weld upset is bulk deformation resulting from the application of pressure during welding. The weld upset may be measured as a percent increase in interface area, a reduction in length, a percent reduction in lap joint thickness, or a reduction in cross wire weld stack height. Where welding end caps onto tubing, the reduction in length is measured and recorded by how much the end cap electrodes move during the weld, which is called “weld displacement.”

In some instances, the deformation associated with the weld upset can result in the weld upset contacting one or both of the electrode fixtures, which allows the weld current to bypass the weld joint by flowing through the weld upset into the electrode fixtures. When this occurs, additional weld current primarily contributes to heating the components instead of heating the joint between the components being welded. Additionally, when once the weld upset is in electrical-conductive contact with the electrode fixture, the weld is done and no longer can be improved. To prevent this electrical-conductive contact between the weld upset and the electrode fixture, areas of the electrode fixtures that are capable of contacting the weld upset are electrically insulated.

In the example shown in FIG. 1, at least portions of both the first electrode fixture 12 and the second electrode fixture 22 are electrically insulated by each including an electrically isolating insert. For example, a first electrically isolating insert 16 is inset in a surface 14 of the first electrode fixture 12 and a second electrically isolating insert 26 is inset in a surface 24 of the second electrode fixture 22.

It should be noted that in other embodiments, only one of the first electrode fixture 12 and the second electrode fixture 22 are electrically insulated. It should be further noted that other forms of electrical isolation in place of, or in addition to, an electrically isolating insert can be used to prevent the noted electrical-conductive contact, such as coatings on the electrode fixtures, coatings on the workpieces, or combinations of electrically isolating insert(s) and coating(s) (and that these other forms can be provided on one or both electrode fixtures/workpieces).

The portions of the electrode fixtures that are electrically isolated, whether by electrically isolating insert(s) and/or coating(s), are the portions on the face of the electrode fixtures oriented toward the weld location and that are circumferential to the electrode fixture's receiving channel. The radial length of these circumferential portions are sized so that an upset of the weld does not extend radially past the circumferential portion.

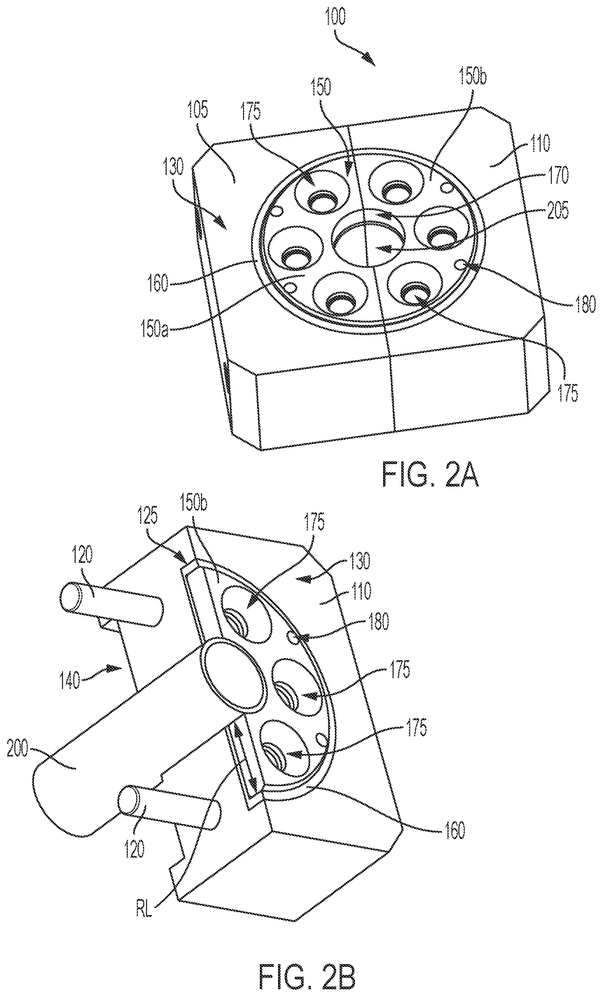

FIGS. 2A and 2B are schematic, perspective views of an embodiment of an insulated electrode fixture for resistance welding. The insulated electrode fixture 100 includes a first body 105 and a second body 110. One or both of the first body 105 and the second body 110 can optionally include guide pins 120 with cooperating guide channels (not shown) to allow the first body 105 and the second body 110 to be removably joined together. FIG. 2A shows an assembled view of the insulated electrode fixture 100 and FIG. 2B shows a disassembled, partial view of one insulated electrode fixture 100 with a workpiece 200. The workpiece 200 is positioned in a receiving channel 205 that extends through the insulated electrode fixture 100 from a first side 130 to a second side 140. Joining the first body 105 and the second body 110 applies a clamping force, such as a circumferential clamping force, to workpiece 200 positioned in the receiving channel 205, resulting in the workpiece 200 being in electrical conductive contact with the first body 105 and the second body 110 through the surfaces of the receiving channel 205.

In some embodiments, the insulated electrode fixture 100 also includes an electrically isolated insert 150. The electrically isolated insert 150 is located on or embedded into the surface of one of the bodies 105,110 of the insulated electrode fixture 100. For example and as shown in FIGS. 2A and 2B, the electrically isolated insert 150 is embedded into a recess 125 formed in the surface of the first side 130 of the insulated electrode fixture 100. As seen in FIGS. 2A and 2B, the recess 125 (and thus the electrically isolated insert 150 that is embedded into the recess 125) is located at a portion of the surface of the bodies 105,110 of the electrode fixture 100 that is circumferential to the electrode fixture's receiving channel 205 and has a radial length RL from the opening 170 that corresponds to the receiving channel 205 to the radial periphery of the electrically isolated insert 150.

Additionally and as shown, the recess 125 can be formed with a portion in the first body 105 and a portion in the second body 110 and the electrically isolated insert 150 can be in two portions 150a, 150b, one for each of the portions of the recess 125. In other embodiments, the electrically isolated insert 150 is a single body. The electrically isolated insert 150 includes an opening 170 corresponding to the receiving channel that extends through the insulated electrode fixture 100 (in some embodiments, the opening 170 can be formed by features, e.g., semicircular openings, in the respective two portions 150a, 150b). The opening 170 can have the same radius or a larger radius than the receiving channel 205. If a larger radius for opening 170 is used, then that larger radius allows an outer upset to form and be shaped by the surfaces of the opening 170.

In FIGS. 2A and 2B, the electrically isolated insert 150 is formed of an electrically conductive material, such as a metal. As an example, for workpieces formed of high temperature refractory metal alloy, the electrically isolated insert 150 can be formed of tungsten. Therefore, the insulated electrode fixture 100 also includes an insulator 160 positioned between the electrically isolated insert 150 and the first body 105 and the second body 110. For example, the insulator 160 can be positioned in the recess 125 and is between the bottom and side walls of the recess 125 and the bottom surface and side surface of the electrically isolated insert 150. As examples, the insulator 160 can be formed of a high temperature polymer, a non-conductive ceramic, or a polymer composite. Examples of high temperature polymers includes polyaryletherketone (PAEK) polymers, such as polyetherketone (PEK), polyetheretherketone (PEEK), and fluoropolymers, such as polytetrafluoroethylene (PTFE). Examples of non-conductive ceramics include alumina, steatite, and porcelain/clay ceramics.

In addition, the electrically isolated insert 150 includes one or more openings 175 for fasteners that affix the electrically isolated insert 150 to the insulated electrode fixture 100. When the electrically isolated insert 150 is formed of an electrically conductive material, the fasteners are non-conductive fasteners, such as non-conductive screws or non-conductive threaded inserts.

In addition, the electrically isolated insert 150 optionally includes one or more registration features that can be used to orient the insert 150 in a particularly position relative to the bodies 105, 110. An example registration feature is a hole 180 in the insert 150. A corresponding registration feature can be present on the insulated electrode fixture 100, such as on bodies 105, 110, that cooperate with the registration feature in the insert 150 (for example, by mating together). One or more registration features can be used.

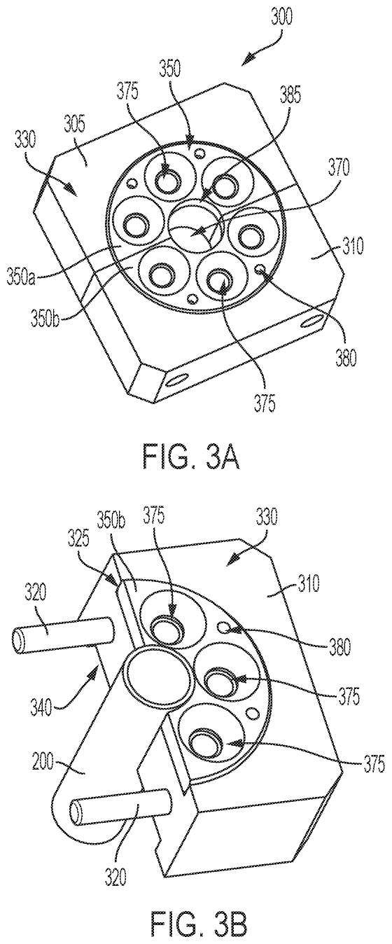

FIGS. 3A and 3B are schematic, perspective views of another embodiment of an insulated electrode fixture for resistance welding. The insulated electrode fixture 300 includes a first body 305 and a second body 310. The first body 305 and second body 310 can be the same as or differ from the first body 105 and second body 110 of the embodiment of an insulated electrode 100 shown and described in FIGS. 2A and 2B. One or both of the first body 305 and the second body 310 can optionally include guide pins 320 with cooperating guide channels (not shown) to allow the first body 305 and the second body 310 to be removably joined together. FIG. 3A shows an assembled view of the insulated electrode fixture 300 and FIG. 3B shows a disassembled, partial view of the insulated electrode fixture 300 with a workpiece 200. The workpiece 200 is positioned in a receiving channel 370 that extends through the insulated electrode fixture 300 from a first side 330 to a second side 340. Joining the first body 305 and the second body 310 applies a clamping force, such as a circumferential clamping force, to workpiece 200 positioned in the receiving channel 370 and results in the workpiece 200 being in electrical conductive contact with the first body 305 and the second body 310.

The insulated electrode fixture 300 also includes an electrically isolated insert 350. The electrically isolated insert 350 is located on or embedded into the surface of one of the sides of the insulated electrode fixture 300. For example and as shown in FIGS. 3A and 3B, the electrically isolated insert 350 is embedded into a recess 325 formed in the surface of the first side 330 of the insulated electrode fixture 300. Additionally and as shown, the recess 325 can be formed with a portion in the first body 305 and a portion in the second body 310 and the electrically isolated insert fixture 350 can be in two portions 350a, 350b, one for each of the portions of the recess 325. In other embodiments, the electrically isolated insert 350 is a single, unitary body. The electrically isolated insert 350 includes an opening 385 corresponding to the receiving channel 370 that extends through the insulated electrode fixture 300 (in some embodiments, the opening 385 can be formed by features, e.g., semicircular openings, in the respective two portions 350a, 350b). In alternative embodiments, the opening 385 can be larger, e.g., in cross-sectional area or in diameter, than the receiving channel 370 to accommodate an outer upset.

In FIGS. 3A and 3B, the electrically isolated insert 350 is formed of an electrically non-conductive material, such as a ceramic. In other embodiments, the electrically isolated insert 350 can be formed of an electrically conductive material that has a coating of a non-conductive material. In still other embodiments, the electrically isolated insert 350 can be formed of an electrically conductive material and the recess 325 has a coating of a non-conductive material. As an example, (i) the electrically isolated insert 350 can be non-conductive and formed of zirconia or (ii) the electrically isolated insert 350 can be conductive and formed steel and the electrically isolated insert 350 is coated with (and/or the recess is coated with) a non-conductive material, such as a ceramic or an oxide, such as aluminum oxide or zirconia. Because the electrically isolated insert 350 is formed of an electrically non-conductive material or of an electrically conductive material that is isolated from the insulated electrode fixture 300 by a coating of a non-conductive material, the insulated electrode fixture 300 in this embodiment can be without an insulator. This arrangement is different from the embodiment of the insulated electrode fixture 100 using an insert 150 formed of an electrically conductive material shown and described in FIGS. 2A and 2B. However, an insulator (similar to insulator 160 shown and described in FIGS. 2A and 2B) can optionally be included in the insulated electrode fixture 300 in this embodiment. For example, including an insulator in the insulated electrode fixture 300 in this embodiment can provide an additional feature to electrically isolate the insert 350 from the bodies 305, 310 of the insulated electrode fixture 300. Using an optional insulator may be more preferable when the electrically isolated insert 350 is formed of an electrically conductive material that has a coating of a non-conductive material or when the electrically isolated insert 350 is formed of an electrically conductive material and the recess 325 has a coating of a non-conductive material.

In addition, the electrically isolated insert 350 includes one or more openings 375 for fasteners that affix the electrically isolated insert 350 to the insulated electrode fixture 300. When the electrically isolated insert 350 is formed of an electrically non-conductive material, the fasteners can be conductive fasteners, such as conductive screws or conductive threaded inserts made from a metal. When the electrically isolated insert 350 is formed of an electrically conductive material, the fasteners can be either conductive fasteners or non-conductive fasteners. However, non-conductive fasteners may be preferred to ensure that the fasteners do not create a path for electrical conduction from the head of the fasteners to the insulated electrode fixture 300.

In addition, the electrically isolated insert 350 optionally includes one or more registration features that can be used to orient the insert in a particularly position relative to the bodies 305, 310. An example registration feature is a hole 380 in the electrically isolated insert 350. A corresponding registration feature can be present on the insulated electrode fixture 300, such as on bodies 305, 310, that mate with the registration feature in the electrically isolated insert 350. One or more registration features can be used.

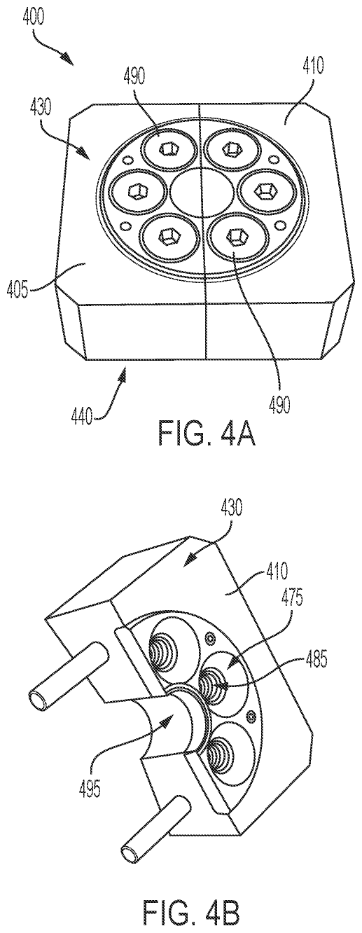

FIGS. 4A and 4B are images of an example insulated electrode fixture 400 for resistance welding, with FIG. 4A showing an assembled view and FIG. 4B showing a disassembled, partial view. The insulated electrode fixture 400 for resistance welding in the images in FIGS. 4A and 4B is similar to the insulated electrode 300 shown and described in FIGS. 3A and 3B. Also shown are threaded openings 485 in the bodies 405, 410 of the insulated electrode fixture 400 that threadedly receive fasteners 490 (in FIG. 4B, the threaded openings 485 are visible through openings 475 in the insert 450). Also visible in FIG. 4B is the receiving channel 495 that extends through the insulated electrode 400 from a first side 430 to a second side 440 and that receives the workpiece (not shown). The insert 450 can be formed of an electrically non-conductive material or of an electrically conductive material that is isolated from the insulated electrode fixture 400 by a coating of a non-conductive material.

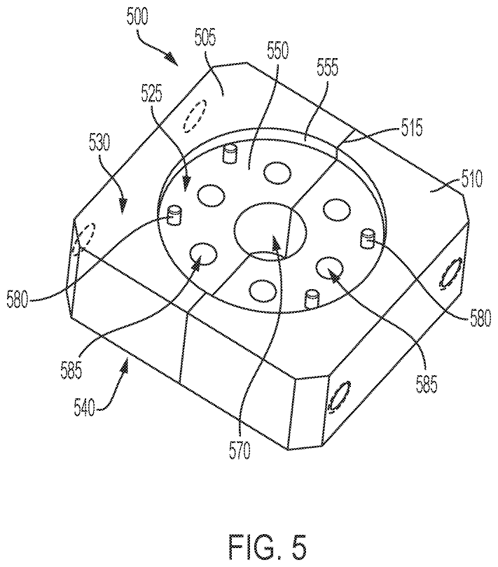

FIG. 5 is a schematic, perspective view of an additional embodiment of an insulated electrode fixture for resistance welding. The illustrated insulated electrode fixture 500 has two bodies 505, 510 that join together along an interface 515.

Guide pins with cooperating guide channels (not shown) can optionally be utilized to facilitate removably joining the first body 505 and the second body 510. The insulated electrode fixture 500 includes a recess 525 for an electrically isolated insert (not shown in FIG. 5) and a receiving channel 570 that extends through the insulated electrode fixture 500 from a first side 530 to a second side 540 and that receives the workpiece (not shown). The recess 525 includes a bottom surface 550 and, depending on geometry of the electrically isolated insert, one or more side surfaces 555 around a circumference of the recess 525. One or more registration features 580 protrude from the bottom surface 550 of the recess 525 and can be used to orient the insert in a particularly position relative to the bodies 505, 510.

The insulated electrode fixture 500 can include openings 585 in the bodies 505, 510 for receiving a fastener to attach the electrically isolated insert to the insulated electrode fixture 500. The openings 585 can optionally be threaded to receive threaded fasteners.

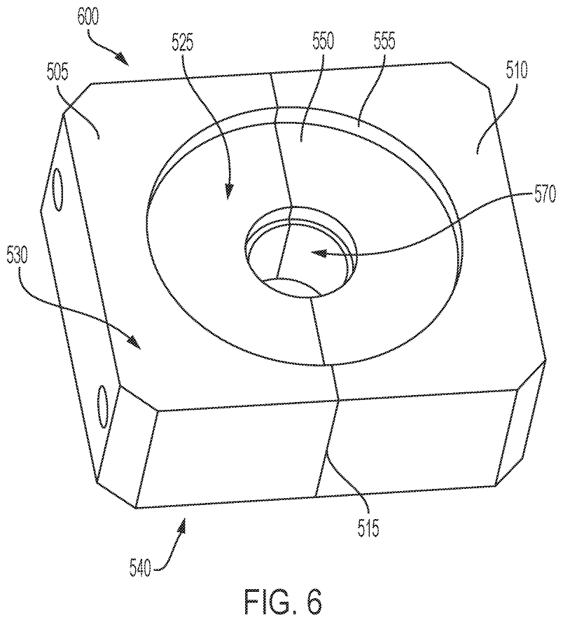

FIG. 6 is a schematic, perspective view of a further embodiment of an insulated electrode fixture for resistance welding. The embodiment of the insulated electrode fixture 600 in FIG. 6 is similar to that shown in FIG. 5, but does not have certain features, such as openings in the bodies for receiving a fastener or registration features.

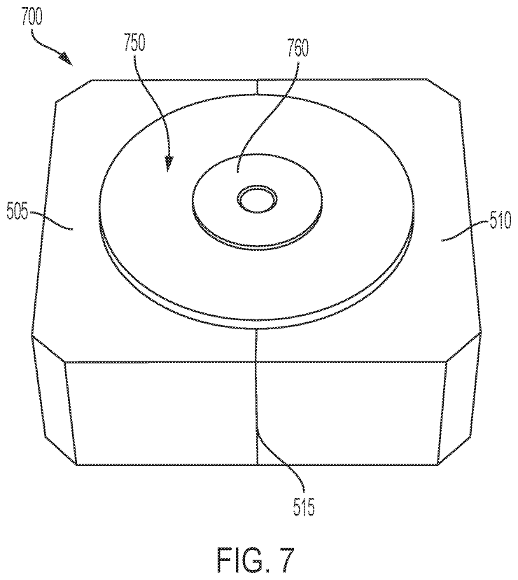

FIG. 7 is an image of an example insulated electrode fixture 700 for resistance welding. The insulated electrode fixture 700 for resistance welding in the image in FIG. 7 is similar to the insulated electrode fixture 600 shown and described in FIG. 6. As shown in FIG. 7, an electrically isolated insert 750 is positioned in the recess. Even though the insulated electrode fixture 700 is formed of two bodies 505, 510, the electrically isolated insert 750 in this embodiment is formed as a unitary body of PEK. A Mo—W-alloy disk 760 is positioned in the opening in the electrically isolated insert 750.

In some embodiments, a non-conductive coating is applied to the bottom surface and one or more side surfaces of the recess. This non-conductive coating can also optionally be present on the surfaces of the openings in the bodies for receiving a fastener and/or on the surfaces of registration features. However, at least a portion of surfaces of the receiving channel, alternatively all surfaces of the receiving channel, should not have a non-conductive coating so that such non-coated surfaces can make adequate electrical conduct between the insulated electrode fixture and the workpiece to provide an electrical connection to the respective workpiece and so that the electrode fixtures function as electrodes in the upset welding process. Non-coated surfaces of the receiving channel can be achieved by various means, including masking the surfaces during deposition of the non-conductive coating or machining away, such as by grinding, the non-conductive coating post-deposition.

In exemplary embodiments, the first body and the second body of the insulated electrode fixture are formed of an electrically conductive composition, such as copper or a copper-based alloy. Examples include 100% copper as well as beryllium-copper and tungsten-copper alloys, where the beryllium or the tungsten is present up to 80 wt %, alternatively in an amount of 25 to 75 wt % or 45 to 55 wt %.

In illustrated embodiments, the workpiece is a tube and the receiving channel in each of the first body 105, 305 and second body 110, 310 is a half cylinder conformal to the outer surface of the workpiece, e.g., a tube. However, other types of workpieces, such as a solid rod or tube, and other shapes of the receiving channel, such as rectangular tubing or a rectangular bar, can also be used.

The following Table 1 includes values for dimensions of an example insulated electrode fixture. However, insulated electrode fixtures can have dimensions smaller and larger than those in Table 1, as suitable for the welding operation.

TABLE 1

| Feature | Dimension |
|---|---|
| insulated electrode fixture | 1.6 × 1.6 × 0.4 inches |
| (overall) | (4 × 4 × 1 cm) (L × W × H) |
| bodies of insulated | 1.6 × 0.8 × 0.4 inches |
| electrode fixture | (4 × 2 × 1 cm) (L × W × H) |
| recess | 1.2 inches (about 3 cm) diameter |
| | 0.10 inches (about 0.25 cm) depth |
| insert | 1.1 inches (about 2.8 cm) diameter |
| | 0.11 inches (about 0.28 cm) thickness |
| | RL = 0.4 inches (about 1 cm) |
| insulating layer | 0.010 inches (about 0.025 cm) thickness |

In alternative embodiments, the insulated electrode fixture does not include a recess. Rather, an insulated plate(s) or other flat structure(s) is placed on the sides of the electrode bodies in the area adjacent the receiving channel.

In further alternative embodiments, the insulated electrode fixture can be double-sided and, once the first side of the insulated electrode fixture wears in the upset area, the insulated electrode fixture can be turned over and the second side of the insulated electrode fixture put into service. By utilizing both sides of the insulated electrode fixture, the insulated electrode fixture life is 2× the number of welds.

Resistance welding utilizing the disclosed insulated electrode fixture can be utilized in various welding applications. For example, the disclosed insulated electrode fixture can be used for welding medical needles or of nuclear components, such as reactor vessel coolant piping.

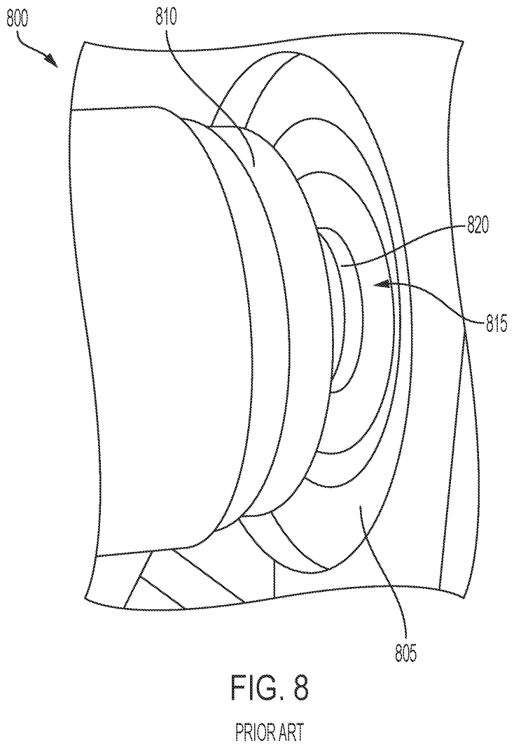

FIG. 8 is a prior art image 800 of resistance welding of an end cap to a tube and showing the weld upset and a non-insulated electrode fixture for resistance welding. In the prior art welding process shown in FIG. 8, a first workpiece (in this example, a tube) is positioned in a first non-insulated electrode fixture 805 and a second workpiece (in this example, an endcap for the tube) is positioned in a second non-insulated electrode fixture 810. In the first non-insulated electrode fixture 805, the circumferential area 815 around the receiving channel in which the tube is located does not include an electrically isolated insert (as disclosed herein) a weld upset 820 is forming and extends radially outward from the weld joint. Over time, this weld upset can contact the non-insulated electrode fixture 805 and weld current can bypass the weld joint by flowing through the weld upset into the weld electrode(s). The prior art image 800 demonstrates the need for and the benefits from the disclosed insulated electrode fixture for resistance welding.

While reference has been made to specific embodiments, it is apparent that other embodiments and variations can be devised by others skilled in the art without departing from their spirit and scope. The appended claims are intended to be construed to include all such embodiments and equivalent variations.

What is claimed is:

1. An insulated electrode fixture, comprising:
an electrically conductive body including a first side, a second side, and a receiving channel extending through the electrically conductive body from the first side to a second side; and
an insert located on the first side and circumferential to the receiving channel,
wherein the receiving channel is configured to receive a workpiece with surfaces of the receiving channel in electrical conductive contact with the electrically conductive body, and
wherein the insert is electrically isolated from the electrically conductive body.

2. The insulated electrode fixture according to claim 1, wherein the electrically conductive body further includes a recess in the first side and the insert is embedded into the recess.

3. The insulated electrode fixture according to claim 2, wherein the insert is formed of an electrically conductive material, and wherein the insulated electrode fixture further includes an insulator positioned between the electrically isolated insert and the electrically conductive body.

4. The insulated electrode fixture according to claim 3, wherein the insulator is formed of a high temperature polymer.

5. The insulated electrode fixture according to claim 4, wherein the high temperature polymer is a polyaryletherketone (PAEK) polymer or a fluoropolymer.

6. The insulated electrode fixture according to claim 2, wherein the insert is formed of an electrically non-conductive material.

7. The insulated electrode fixture according to claim 6, wherein the electrically non-conductive material is a ceramic.

8. The insulated electrode fixture according to claim 2, wherein the insert is formed of an electrically conductive material and wherein the insulated electrode fixture further includes a coating of a non-conductive material on at least one of the electrically isolated insert and the electrically conductive body so that the coating is positioned between the electrically isolated insert and the electrically conductive body.

9. The insulated electrode fixture according to claim 8, wherein the insulated electrode fixture further includes an insulator positioned between the electrically isolated insert and the electrically conductive body.

10. The insulated electrode fixture according to claim 1, wherein the insert is formed of an electrically conductive material, and wherein the insulated electrode fixture further includes an insulator positioned between the electrically isolated insert and the electrically conductive body,
wherein the insulator is formed of a high temperature polymer, and
wherein a radial length of the insert in a direction of a plane containing the first side is sized so that an upset of a weld does not extend radially past an outermost periphery of the insert.

11. The insulated electrode fixture according to claim 1, wherein the insert is formed of an electrically non-conductive ceramic material, and
wherein a radial length of the insert in a direction of a plane containing the first side is sized so that an upset of a weld does not extend radially past an outermost periphery of the insert.

12. The insulated electrode fixture according to claim 1, wherein the insert is formed of an electrically conductive material,
wherein the insulated electrode fixture further includes a coating of a non-conductive material on at least one of the electrically isolated insert and the electrically conductive body so that the coating is positioned between the electrically isolated insert and the electrically conductive body,
wherein the insulated electrode fixture further includes an insulator positioned between the electrically isolated insert and the electrically conductive body, and
wherein a radial length of the insert in a direction of a plane containing the first side is sized so that an upset of a weld does not extend radially past an outermost periphery of the insert.

13. The insulated electrode fixture according to claim 1, wherein a radial length of the insert in a direction of a plane containing the first side is sized so that an upset of a weld does not extend radially past an outermost periphery of the insert.

14. The insulated electrode fixture according to claim 1, wherein the insert includes an opening corresponding to the receiving channel.

15. The insulated electrode fixture according to claim 14, wherein a cross-sectional area of the opening is larger than a cross-sectional area of the receiving channel.

16. The insulated electrode fixture according to claim 1, wherein the insert includes one or more openings for fasteners that affix the insert to the electrically conductive body.

17. The insulated electrode fixture according to claim 1, wherein the insert and the electrically conductive body include one or more cooperating registration features configured to orient the insert relative to the electrically conductive body.

18. The insulated electrode fixture according to claim 1, wherein the electrically conductive body includes a first body and a second body, and wherein the first body and a second body are configured to join together along an interface to form the electrically conductive body.

19. The insulated electrode fixture according to claim 18, wherein the first body and the second body include guide pins with cooperating guide channels configured to removably join together the first body and the second body.

20. The insulated electrode fixture according to claim 1, wherein the insert is a unitary body.

21. The insulated electrode fixture according to claim 1, wherein the insert includes two portions.

22. A welding system, comprising:
a welding transformer; and
the insulated electrode fixture according to claim 1,
wherein the insulated electrode fixture is electrically connected to the welding transformer for the insulated electrode fixture to function as an electrode in a welding process.

23. A method of joining a first workpiece to a second workpiece, the method comprising:
seating the first workpiece in a first receiving channel of a first electrode fixture and seating the second workpiece in a second receiving channel of a second electrode fixture, wherein at least one of the first electrode fixture and the second electrode fixture is the insulated electrode fixture according to claim 1;
moving faying surfaces of the first workpiece and the second workpiece into contact with each other at a weld joint; and
applying a force urging the first workpiece and the second workpiece toward each other during a welding process.

24. The method according to claim 23, wherein the welding process is an upset welding process.
